(19) United States
(12) Patent Application Publication
(10) Pub. No.: US 2026/0296388 A1
(43) Pub. Date: Oct. 1, 2026

(54) METHOD FOR DETECTING AND CONTROLLING WHEEL SLIP OF AN ELECTRICAL TRAILER BRAKING SYSTEM

(71) Applicant: Ford Global Technologies, LLC, Dearborn, MI (US)

(72) Inventor: Matthew Guy Hait, Oak Park, MI (US)

(73) Assignee: Ford Global Technologies, LLC, Dearborn, MI (US)

(21) Appl. No.: 19/089,564

(22) Filed: Mar. 25, 2025

(51) Int. Cl. B60T 8/1761; B60T 8/17; B60T 8/171; B60T 8/172

(52) U.S. Cl. CPC B60T 8/1761; B60T 8/1701; B60T 8/171; B60T 8/172; B60T 2250/02; B60T 2250/04

(57) ABSTRACT

A trailer brake control system includes a trailer brake control output connection, and a controller including a memory storing a combined vehicle and trailer mass. The controller, responsive to a vehicle brake signal indicating application of a vehicle brake system, outputs a trailer brake signal via the trailer brake control output connection. The controller determines an effective combined brake torque by multiplying the combined vehicle and trailer mass by a vehicle acceleration signal and by a braked tire radius, determines an effective trailer brake torque by subtracting a commanded vehicle brake torque, derived from the vehicle brake signal, from the effective combined brake torque, and detects a trailer wheel slip condition responsive to the effective trailer brake torque being less than an estimated trailer brake torque, determined from the trailer brake signal. Responsive to detecting the trailer wheel slip condition, the controller adjusts the trailer brake signal.

### FIELD OF THE DISCLOSURE

The present disclosure generally relates to a method for detecting and controlling wheel slip in an electrical trailer braking system. Specifically, it relates to a solution for implementing an anti-lock braking system (“ABS”) in consumer trailers equipped with electric or electric over hydraulic (“EOH”) brakes.

### BACKGROUND OF THE DISCLOSURE

Existing trailer brake systems may be configured to receive a brake torque demand signal from a brake control device. These systems typically include a calibration input for adjustment of a gain applied to the brake torque demand signal to achieve the output trailer brake control signal. As such, a test actuation input is also provided that can allow the user to test the result of the trailer brake control signal output at a current gain level to determine if the resulting brake application is too low

Consumer trailers typically lack ABS, which is widely used in vehicles to prevent wheel lock during braking. The absence of ABS in a trailer can lead to increased braking distances and potential trailer instability due to wheel lockup. Existing ABS solutions are often cost-prohibitive and may require substantial modifications or additions to the trailer braking system, including the installation of a dedicated ABS control module. Without a dedicated ABS control module systems, wheel lockup can occur due to high “trailer gain” settings on a standard trailer brake controller or unexpected changes in road surface conditions.

### SUMMARY OF THE DISCLOSURE

According to one aspect of the present disclosure, a trailer brake control system for a vehicle includes a vehicle acceleration sensor outputting a vehicle acceleration signal, a vehicle velocity sensor outputting a vehicle velocity signal, a vehicle brake system outputting a vehicle brake signal, a trailer brake control output connection, and a controller including a memory storing a combined vehicle and trailer mass. The controller receives the vehicle brake signal, the vehicle acceleration signal, and the vehicle velocity signal and, responsive to the vehicle brake signal indicating application of the vehicle brake system, outputs a trailer brake signal via the trailer brake control output connection. The controller further determines an effective combined brake torque by multiplying the combined vehicle and trailer mass by the vehicle acceleration signal and by a braked tire radius, determines an effective trailer brake torque by subtracting a commanded vehicle brake torque, derived from the vehicle brake signal, from the effective combined brake torque, and detects a trailer wheel slip condition responsive to the effective trailer brake torque being less than an estimated trailer brake torque, determined from the trailer brake signal. Responsive to detecting the trailer wheel slip condition, the controller adjusts the trailer brake signal.

Embodiments of the first aspect of the invention can include any one or a combination of the following features:
the controller may adjust the trailer brake signal to reduce the trailer brake torque command using a proportional-integral control scheme that uses a difference between the effective trailer brake torque and the estimated trailer brake torque as an input.
the controller, during application of the vehicle brake system, may continually output the trailer brake signal, detect the trailer wheel slip condition, and responsive to detecting the trailer wheel slip condition, adjust the trailer brake signal to converge a difference between the effective trailer brake torque and the estimated trailer brake torque to below a predetermined threshold.
the estimated trailer brake torque may be determined from the trailer brake signal using a lookup table including a plurality of estimated trailer brake torque values corresponding with preselected trailer brake signal and trailer brake gain values.
the controller can further correct at least one of the plurality of estimated trailer brake torque values responsive to a measured error between the estimated trailer brake torque and the estimated trailer brake torque during a non-trailer wheel slip condition.
the trailer brake signal can be determined based on the vehicle brake signal, the vehicle velocity signal, and at least one trailer brake system setting.
the braked tire radius can be a single assumed value for all of a plurality of braked vehicle wheels and braked trailer wheels.

According to another aspect of the present disclosure, a trailer brake control system for a vehicle includes a vehicle acceleration sensor outputting a vehicle acceleration signal, a vehicle velocity sensor outputting a vehicle velocity signal, a vehicle brake system outputting a vehicle brake signal, a trailer brake control output connection, and a controller including a memory storing a combined vehicle and trailer mass. The controller receives the vehicle brake signal, the vehicle acceleration signal, and the vehicle velocity signal and, responsive to the vehicle brake signal indicating application of the vehicle brake system, outputs a trailer brake signal via the trailer brake control output connection. The controller further determines an effective combined brake torque by multiplying the combined vehicle and trailer mass by the vehicle acceleration signal and by a braked tire radius, determines a commanded combined brake torque as a sum of a commanded vehicle brake torque, derived from the vehicle brake signal, and a trailer brake torque, determined from the initial trailer brake signal, and detects a trailer wheel slip condition responsive to the commanded combined brake torque varying from the effective combined brake torque by a predetermined amount. Responsive to detecting the trailer wheel slip condition, the controller adjusts the trailer brake signal to reduce a trailer brake torque command.

According to another aspect of the present disclosure, a method for mitigating wheel slip in a braked trailer wheel includes receiving a vehicle brake signal from a vehicle brake system, a vehicle acceleration signal from a vehicle acceleration sensor, and a vehicle velocity signal. Responsive to the vehicle brake signal indicating application of the vehicle brake system, a trailer brake signal is output via a trailer brake control output connection. The method further includes determining an effective combined brake torque by multiplying a combined vehicle and trailer mass by the vehicle acceleration signal and by a braked tire radius, determining an effective trailer brake torque by subtracting a commanded vehicle brake torque, derived from the vehicle brake signal, from the effective combined brake torque, and detecting a trailer wheel slip condition responsive to the effective trailer brake torque being less than an estimated trailer brake torque, determined from the trailer brake signal. Responsive to detecting the trailer wheel slip condition, the method includes adjusting the trailer brake signal.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of an example vehicle and trailer having a trailer brake control system;

FIG. 2 is a diagram of a vehicle and trailer combination showing aspects of the trailer brake control system;

FIG. 3 is a system diagram showing the trailer brake control system and related components;

FIG. 4 is a block diagram showing the operation of the trailer brake control system;

FIG. 5 is a logic diagram depicting a module for determining an effective trailer brake torque realized in the system of FIG. 4;

FIG. 6 is a logic diagram depicting a module for detecting a trailer wheel lockup condition in the system of FIG. 4;

FIG. 7 is a graphical depiction of a trailer wheel slip condition in a related art trailer brake system;

FIG. 8 is a graphical depiction of a trailer wheel slip mitigation function the trailer brake system according to the present disclosure; and

FIG. 9 is a logic diagram depicting a module for correcting an estimated trailer brake torque value in the system of FIG. 4.

### DETAILED DESCRIPTION OF THE PREFERRED EMBODIMENTS

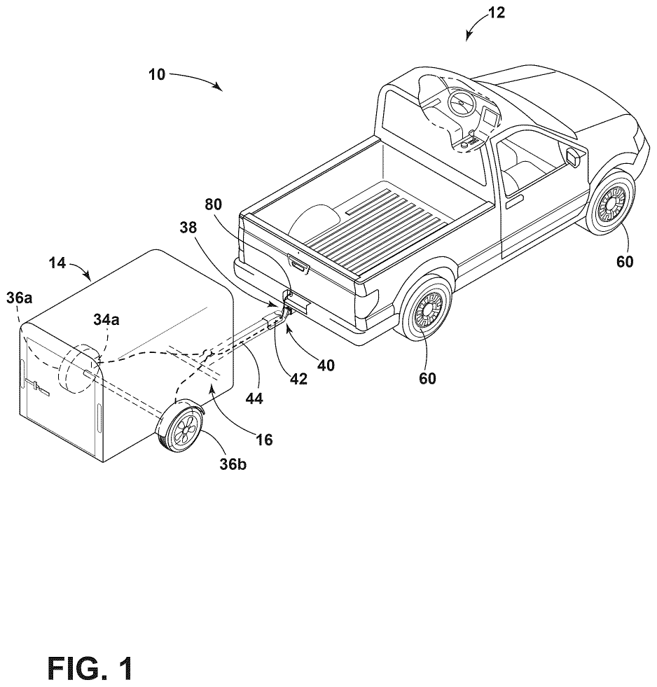

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature or component extending in or along a given direction or the like does not mean that the feature or component follows a straight line or axis in such a direction or that it only extends in such direction or on such a plane without other directional components or deviations, unless otherwise specified.

Ordinal modifiers (i.e., “first”, “second”, etc.) may be used to distinguish between various structures of the disclosed control system in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about,” “approximately,” or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

Referring to FIG. 1-9, reference numeral 10 generally designates a trailer brake control system for a vehicle 12. The control system 10 includes a vehicle acceleration sensor 20 outputting a vehicle acceleration signal 28, a vehicle velocity sensor 30 outputting a vehicle velocity signal 31, a vehicle brake system 54 outputting a vehicle brake signal 24, a trailer brake control output connection 80, and a controller 22 including a memory 68 storing a combined vehicle and trailer mass. In one aspect, the controller 22 may be referred to as a trailer brake controller 22. The controller 22 receives the vehicle brake signal 24, the vehicle acceleration signal 28, and the vehicle velocity signal 31 and, responsive to the vehicle brake signal 24 indicating application of the vehicle brake system 54, outputs a trailer brake signal 26 via the trailer brake control output connection 80. The controller 22 further determines an effective combined brake torque by multiplying the combined vehicle and trailer mass by the vehicle acceleration signal 28 and by a braked tire radius, determines an effective trailer brake torque τ_{t-calc} by subtracting a commanded vehicle brake torque τᵥ₋ₑₛₜ, derived from the vehicle brake signal 24, from the effective combined brake torque, and detects a trailer wheel slip condition responsive to the effective trailer brake torque τt-cale being less than an estimated trailer brake torque τₜ₋ₑₛₜ, determined from the trailer brake signal 26. Responsive to detecting the trailer wheel slip condition, the controller 22 adjusts the trailer brake signal 26.

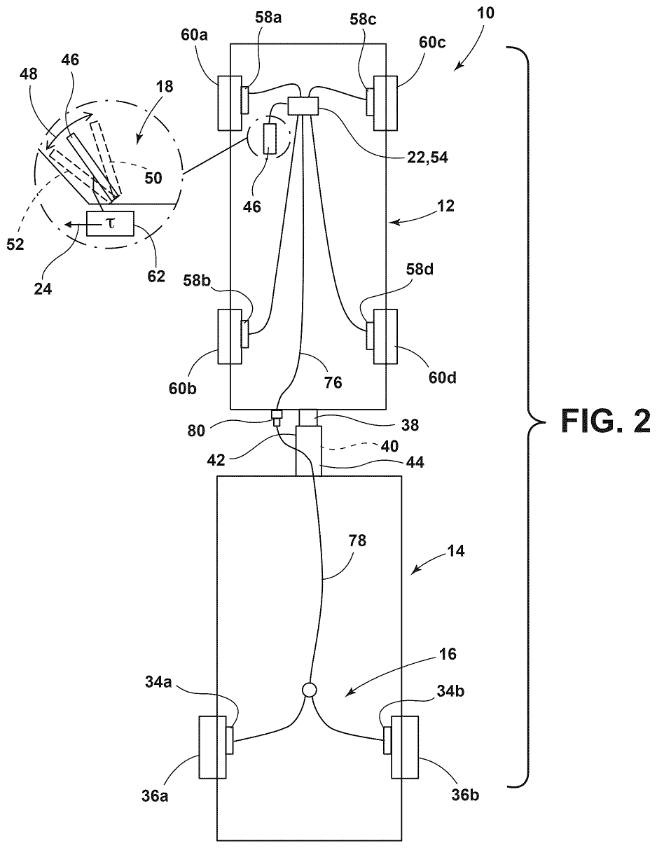

As shown in FIGS. 1 and 2, system 10 is included in vehicle 12, which is depicted as a pickup truck but can be any vehicle capable of towing trailer 14. In one example, the vehicle 12 can be a vehicle with a towing capacity great enough to tow a trailer 14 of a size and/or weight that may require its own trailer brake system 16. Such systems are generally known and as depicted, may include individual trailer brake units 34a and 34b electrically connected to the trailer brake controller 22 and respectively coupled with trailer wheels 36a and 36b to selectively forcibly slow the rotation of wheels 36a and 36b in a coordinated manner with braking of vehicle 12. In this manner, the trailer brake units 34a and 34b can be in the form of disc brakes, drum brakes, or the like and can be generally similar to other known vehicle brakes. In one example, trailer brake units 34a and 34b can be electromechanically actuated such that trailer brake units 34a and 34b operate by directly receiving an electrical signal that drives an electromechanical actuator within the braking mechanism according to the voltage, for example, of the signal. Such a signal can be sent to trailer brake units 34a and 34b by trailer brake controller 22 in the form of brake control signal 26.

In one aspect, the trailer brake controller 22 may simply distribute and transmit the trailer brake control signal 26 among trailer brake units 34a and 34b. In an alternative arrangement, trailer brake system 16 can be what is known as an electric-over-hydraulic system in which trailer brake units 34a and 34b are hydraulically-actuated brake units that are actuated by increased pressure of a hydraulic fluid supply coupled with trailer brake units 34a and 34b. In such an implementation, a trailer brake module can be installed on the trailer 14 and may include a hydraulic pump that pressurizes brake fluid within lines connecting trailer brake module with trailer brake units 34a and 34b according to the trailer brake control signal 26 that trailer brake module receives from the trailer brake controller 22 of vehicle 12.

In any of the specific implementations of trailer brake system 16 described herein and otherwise known, it can be appreciated that the braking force applied to trailer wheels 36a and 36b by trailer brake units 34a and 34b is directly proportional to a characteristic, such as the voltage, of the trailer brake control signal 26. In this manner, and as discussed above, the trailer brake controller 22 can receive the torque demand signal 24 from the brake control device 18 and output trailer brake control signal 26 to trailer brake system 16 to implement a braking force using trailer brake units 34a and 34b that is commensurate with and proportionate to desired braking of vehicle 12. This allows trailer 14 itself, by way of trailer brake system 16 to compensate for the additional weight and resulting momentum of the trailer 14 and the effect thereof on the ability of the combined vehicle 12 and trailer 14 during braking. As illustrated, trailer 14 may be coupled with vehicle 12 by way of a hitch receiver 38 that is coupled with the frame of vehicle 12, hitch receiver 38 having a hitch ball 40 coupled therewith that, in turn, couples in an articulating manner with a trailer hitch 42 disposed on a tongue 44 of trailer 14. Other trailer arrangement and towing assemblies are also known and useable in connection with system 10, including a gooseneck trailer that couples with a “fifth wheel” positioned above and longitudinally and laterally aligned with a center of the rear axle of vehicle 12. Regardless of the particular coupling mechanism, this articulating coupling of vehicle 12 with trailer 14 understandably adds the weight of the trailer 14 and any payload carried by trailer 14 to the total weight that vehicle 12 must accelerate to move and decelerate (i.e., negatively accelerate), in the absence of trailer brake system 16, to slow or stop.

As mentioned above, exiting trailer brake systems may operate proportionately to the vehicle brake signal 24 and a set gain. Notably the vehicle brake signal 24 relates to the level of brake force commanded by the user, and the brake gain, while adjustable to accommodate different towing loads, is not configured or intended for adjustment during a braking action. Accordingly, the present system 10 provides a modified control scheme where, as mentioned above, the trailer brake controller 22 adjusts the trailer brake control signal 26, as needed, to reduce wheel slip of the trailer wheels 36 during braking. As can be appreciated, when braked wheels slip, including when becoming “locked,” during braking, the effectiveness of the braking operation diminishes. Vehicles typically prevent wheel slip or lock by incorporation of an anti-lock brake system (“ABS”) that is configured to detect wheel slip and effectively lower the braking effort by pulsing the brakes, which occurs downstream of the braking command. This operation is generally accepted as not only reducing the braking distance compared to braking with locked wheels or manual brake “pumping,” but also in helping to maintain control of the vehicle during braking, including while steering or maintaining straight tracking of the vehicle.

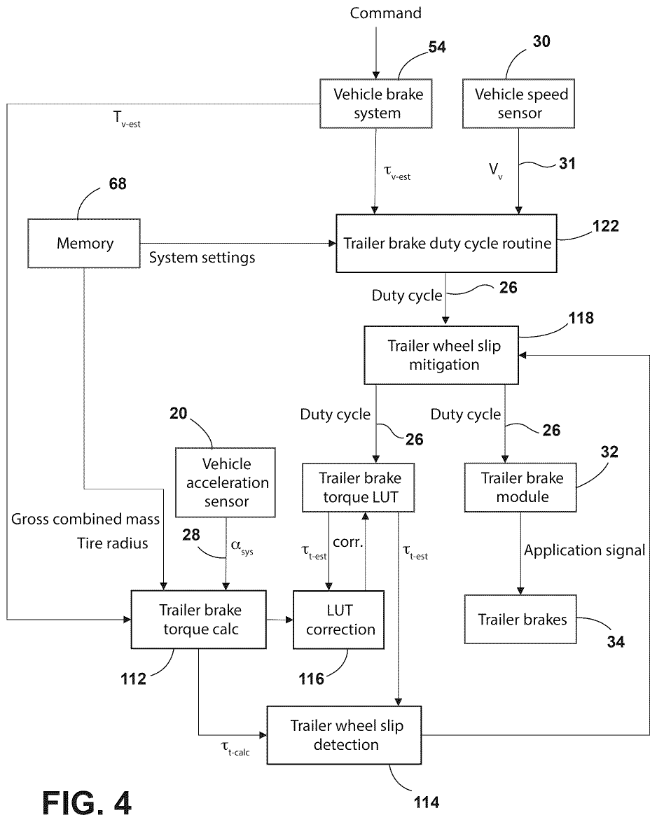

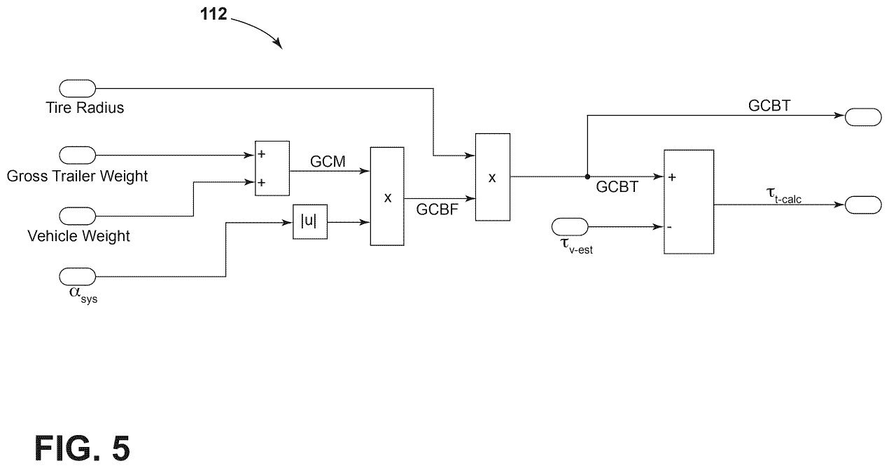

As shown in greater detail in FIGS. 4 and 5, the present system 10 operates to manage wheel slip of the trailer wheels 36 by reducing the trailer brake duty cycle, which in the present example is equivalent to and/or realized from the trailer brake control signal 26. Notably, this scheme is carried out by the towing vehicle 12 by way of the trailer brake controller 22, without the need for additional hardware (i.e., hardware capable of pulsing brake operation) or sensors on the trailer 14. The controller 22 utilizes the wheel speed/velocity sensor 30 and acceleration sensor 20 to calculate the brake torque realized for the vehicle 12 and trailer 14 together. The controller 22 then models the expected torque expected to be realized by trailer braking system 16 separately from that of the vehicle brake system 54 and uses this information to estimate a trailer wheel slip ratio. This slip ratio is then used by the controller 22 to adjust the trailer brake duty cycle by way of the trailer brake control signal 26 to reduce wheel slip and prevent lockup of the trailer wheels 36.

As shown in FIG. 2, brake pedal 46 is coupled with a vehicle brake module 56 of the vehicle brake system 54, which in turn controls the actuation of vehicle brake units 58a, 58b, 58c, and 58d, which apply torque to slow the rotation of the individual vehicle wheels 60a, 60b, 60c, and 60d, which leads to negative acceleration of vehicle 12. In various examples, brake pedal 46 can directly pressurize hydraulic fluid within vehicle brake system 54 with vehicle brake module 56 distributing the pressurized fluid to cause actuation of vehicle brake units 58a, 58b, 58c, and 58d in a predetermined manner (including, for example, by causing higher pressurization in front wheels 60a and 60c). In a further example, vehicle brake module 56 may provide electromechanical assistance to augment or boost the pressure within the hydraulic fluid provided by the position of brake pedal 46 that is proportional (linear or otherwise) to the pressurization provided by the position of brake pedal 46. Still further, brake pedal 46 may be coupled with a position sensor 62 that determines the brake pedal 46 position and outputs a corresponding signal 24, which, as shown in FIG. 4, can be estimated as corresponding with a value τᵥ₋ₑₛₜ by the position of brake pedal 46 within the range 48 of positions. This vehicle brake signal 24 can be electronically output to vehicle brake module 56, which can then electromechanically pressurize hydraulic fluid coupling vehicle brake module 56 with vehicle brake units 58a, 58b, 58c, and 58d. Similarly, the previously-described electromechanically-assisted variation of vehicle brake system 54 can determine the vehicle brake signal 24 and corresponding value τᵥ₋ₑₛₜ based on the level of pressurization provided by the brake pedal 46 (a pressure sensor being considered herein to be position sensor 62), the particular position thereof correlating with such pressurization and being used to determine a desired level of assistance. In a standard hydraulic implementation of vehicle brake system 54, position sensor 62 can be included solely for use in connection with control of the trailer brake system 16, as described herein. In this manner, a particular input made by the driver by way of brake control device 18 through movement of pedal 46 within the proscribed range 48 of motion thereof will cause actuation of the vehicle brake units 58a, 58b, 58c, and 58d to slow vehicle 12 in a manner that is generally predictable (i.e., a certain deceleration rate for a given position of pedal 46) and consistent, absent excessive heating of or wear to components of the vehicle brake units 58a, 58b, 58c, and 58d, such that the estimated vehicle brake torque τᵥ₋ₑₛₜ can be derived by the system 10.

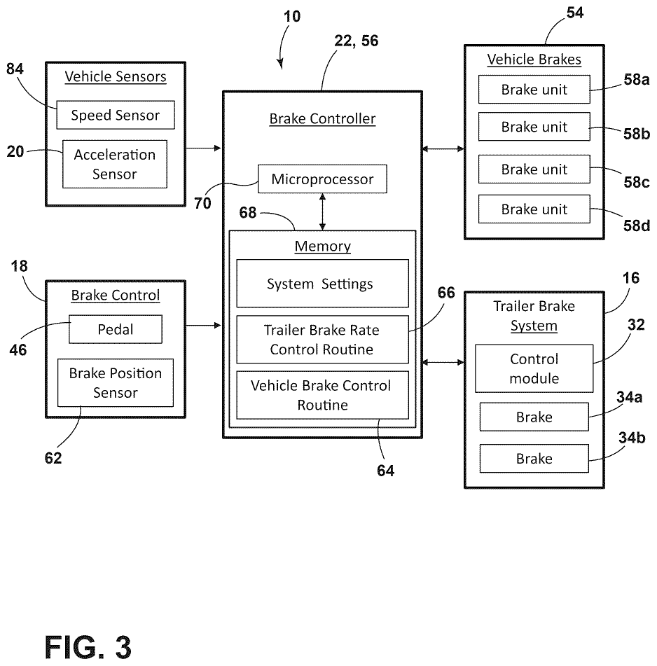

As shown in the system diagram of FIG. 3, the above-described trailer brake controller 22 can be a component of vehicle brake module 56. In an example, vehicle brake module 56 can be an antilock brake system module and can include a vehicle brake control routine 64, which can include the particulars of the above-mentioned electronic assistance functionality and/or controls related to anti-lock functionality, among other controls and routines. Similarly, a trailer brake control routine 66 can also be included that provides the control routine used to output the trailer brake control signal 26, as discussed further below such that vehicle brake module 56 can also function as trailer brake controller 22. Both of these routines can be programmed functionality of vehicle brake module 56 stored in memory 68 and executable by a microprocessor 70 within vehicle brake module 56. In an alternative embodiment, the trailer brake control routine 66 can be included in the general on-board computer system of vehicle 12. Still further, the trailer brake controller 22 can be a stand-alone component in communication with vehicle brake module 56.

In this manner, vehicle brake module 56 including or otherwise incorporating trailer brake controller 22 and/or equivalent functionality therefore, can implement a control scheme that adjusts the trailer brake control signal 26 as an output to converge a determined wheel slip ratio to a predetermined level. As shown in FIG. 4, when the driver depresses brake pedal 46 in an effort to slow the vehicle 12 and trailer 14 combination, the trailer brake controller 22 uses the information related to the use of the vehicle brakes 54 as an indication to activate the trailer brakes 34. More specifically, the trailer brake controller 22 can implement an initial step of the trailer bake routing 66 in which the vehicle brake effort (derived from the brake pedal position 46 directly, from the vehicle brake signal 24, or by way of receipt of the estimated vehicle brake torque τᵥ₋ₑₛₜ, from the vehicle brake system 54). The routine 66 determines the trailer brake control signal 26 in the form of a braking duty cycle in which the output is converted into a pulse width modulated (“PWM”) electrical supply that is fed to the trailer brake units 34a and 34b. The trailer brake routine 66 uses the estimated vehicle brake torque τᵥ₋ₑₛₜ, along with other inputs such as the vehicle velocity vᵥ signal 31, received from the vehicle velocity sensor 30, as well as vehicle or trailer-specific information stored in memory 68, including a trailer brake type setting, a brake initial effort setting, and the trailer brake gain. In various implementations, any stored information related to the vehicle 12 can be stored in the memory 68 at the factor or dealer level, while information related to the trailer 14, including the trailer brake system 16 can be entered by the user or received from the trailer brake controller 22 by electronic transmission through the coupling 80, for example. In instances where multiple different trailers 14 might be used with a single vehicle 12, the system 10 may be able to identify different trailer profiles and associate specific stored information with the trailer 14 being used by way of the coupling 80. As shown, the trailer brake controller 22 causes activation of the trailer brakes 34 according to the duty cycle, which causes application of a braking torque to the trailer wheels 36.

As discussed above, during braking (i.e., during operation of the trailer brake routine 66, upon activation of the vehicle brakes 54 during towing), the controller 22 monitors for wheel slip. In one aspect, the trailer brake controller 22 calculates and stores a gross combined mass (“GCM”) as a sum of the vehicle mass and trailer mass from the corresponding entries therefore in the memory 68. Upon activation of the trailer brakes 34, a gross combined brake force (“GCBF”) is determined by multiplying the GCM by the longitudinal acceleration of the vehicle-trailer combination, according to the acceleration signal 28 as received by the controller 22 from the vehicle acceleration sensor 20. The controller 22 then determines a Gross Combined Brake Torque (“GCBT”) by multiplying the GCBF by the vehicle 12 tire radius. In this respect, it is noted that a single assumed value can be used for the vehicle tire radius, including for the braked trailer wheels 36, while still obtaining an effective calculation for the GCBT. The controller 22 then receives the estimated vehicle brake torque τᵥ₋ₑₛₜ from the vehicle brake system 54 and subtracts that value from the GCBT to determine a calculated trailer brake torque τt-calc. Along with the determination of the calculated trailer brake torque τt-calc, the controller 22 determines an estimated trailer brake torque τₜ₋ₑₛₜ, which corresponds with a torque that the system 10 expects to be realized at the trailer wheels 36 based on the instantaneous duty cycle 26. This is done by way of using the duty cycle 26 to obtain a corresponding value for the estimated trailer brake torque τt-est using a lookup table (“LUT”). The LUT can be pre-populated with estimated torque values for a range of values for the duty cycle 26. These estimates can be trailer-specific, assumed values for a “generic” trailer, or estimates based on ranges of trailer weights (selected using the stored trailer weight as an input) or trailer brake types, or other known or obtainable factors.

As shown in FIG. 5, the controller 22 can then compare the calculated trailer brake torque Tt-calc and the estimated trailer brake torque τₜ₋ₑₛₜ to determine if a trailer wheel slip condition is present. In particular, if no slip condition exists, the calculated trailer brake torque τt-calc and the estimated trailer brake torque τₜ₋ₑₛₜ should be approximately equal such that a condition where the calculated trailer brake torque τ_{t-calc} is less than the estimated trailer brake torque τₜ₋ₑₛₜ it can be determined that a trailer wheel slip condition is present because the realized torque is less than expected. Because this comparison involves an estimate (i.e., estimated trailer brake torque τₜ₋ₑₛₜ), a slight difference between values may not indicate an actual wheel slip condition such that some variation may be permitted before wheel slip is inferred. In this manner, the controller 22 can detect wheel slip when the difference between the calculated trailer brake torque τt-cale and the estimated trailer brake torque τₜ₋ₑₛₜ exceeds a predetermined threshold. In one example, the controller 22 can determine a wheel lock ratio within a range between zero (indicating zero lock) to 1 (indicating complete lock). In an example, the wheel lock ratio can be determined as the difference between the calculated trailer brake torque τt-calc and the estimated trailer brake torque τₜ₋ₑₛₜ over the estimated trailer brake torque τₜ₋ₑₛₜ. In another implementation, the wheel slip ratio can be determined as the difference between the combined estimated vehicle brake torque τᵥ₋ₑₛₜ and estimated trailer brake torque τₜ₋ₑₛₜ and the GCBT over the GCBT.

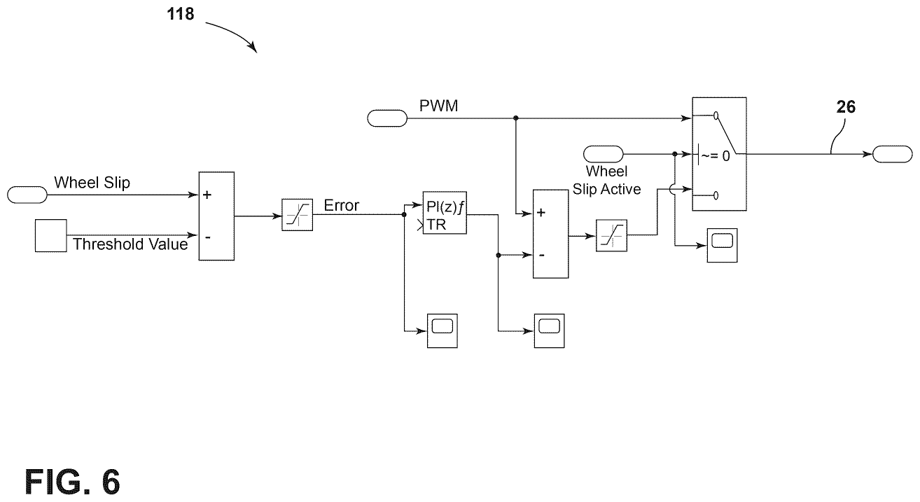

As discussed above, the controller 22 reduces the trailer brake duty cycle 26 to maintain the trailer wheel slip at or below an acceptable level. As shown in FIG. 6, this can be done by configuring the wheel slip mitigation block to incorporate a proportional-integral (“PI”) control scheme, wherein the difference between the calculated wheel slip ratio and a predetermined threshold is used as the error that the PI control scheme operates to converge to zero. In one implementation, the predetermined wheel slip ratio threshold can be between about 8% and 12% and in a further example, about 10%. In one respect, this predetermined ratio can account for differences in the estimated trailer brake torque τₜ₋ₑₛₜ and the actual realized value. In another aspect, the predetermined ratio can also serve to maintain application of the trailer brakes 34 without significant oscillations thereof to prevent lockup in a generally smooth manner. Accordingly, the system 10 may realize a level of controlled wheel slip to prevent wheel lock. Notably, this effect is realized without the need for additional hardware or sensors installed on the trailer. It is further noted that the specific algorithm for assessing the level of wheel slip can vary within the understanding of the system effectively determining a variation, for example, between the calculated trailer brake torque τt-calc and the estimated trailer brake torque τₜ₋ₑₛₜ or a difference between the commanded combined brake torque (i.e., the calculated trailer brake torque τt-calc and the estimated trailer brake torque τₜ₋ₑₛₜ) and the realized combined brake torque (i.e., the GCBT). In this respect, the wheel slip ratio, derived as discussed above, can be representative of such a variation, or in some implementations, the difference can be calculated directly and a target value can be used as the preset for PI control.

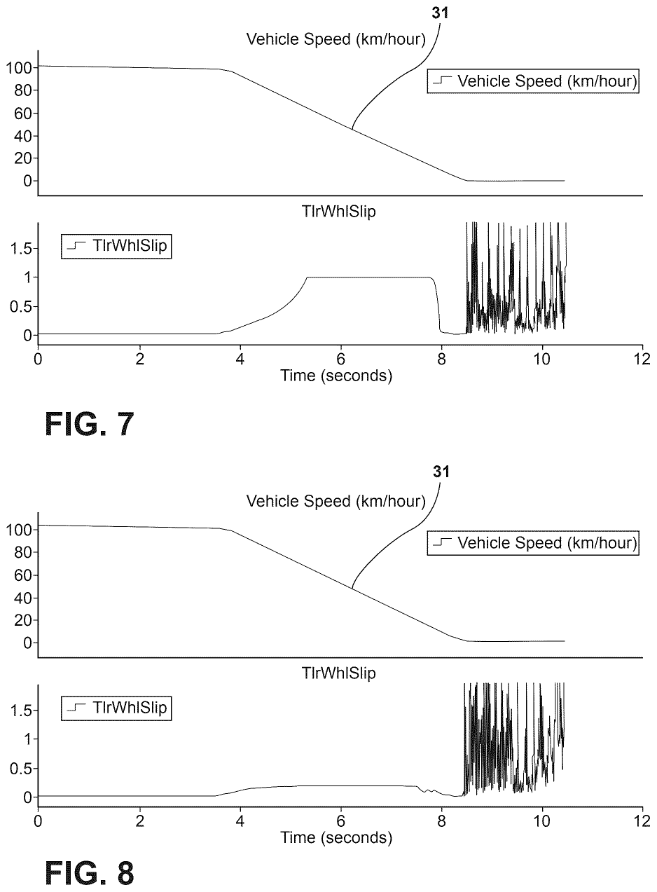

As can be appreciated, the controller 22, during application of the vehicle brake system 54, may continually output the trailer brake signal (duty cycle) 26, while continuously monitoring for a trailer wheel slip condition according to the processes discussed above. In the scheme described above, the controller 22 responds to the detection of a trailer wheel slip condition by adjusting the trailer brake signal 26 to converge the difference between the effective trailer brake torque τt-calc and the estimated trailer brake torque τₜ₋ₑₛₜ to below the predetermined threshold. As shown in FIGS. 7 and 8, the use of the present system 10 can effectively maintain a desired wheel slip ratio (FIG. 8) during slowing of the vehicle 12 to a stop, as indicated by the vehicle speed plotted in the upper chart. In the present implementation, the wheel slip, shown in the bottom graph, is maintained below 0.25 in conditions where a trailer brake control without the present wheel slip mitigation scheme (FIG. 7) experiences a period of total trailer wheel lockup.

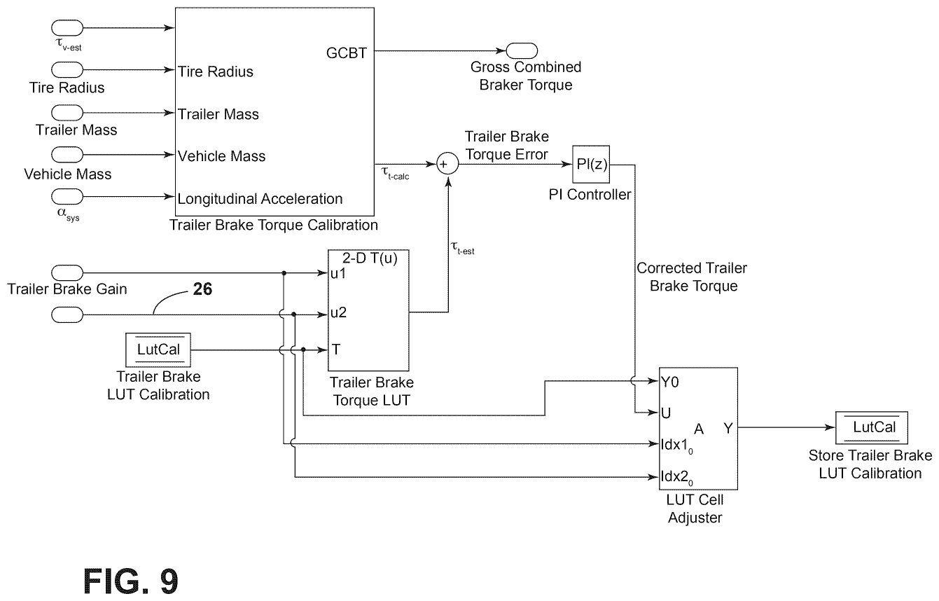

Returning to FIG. 4, the system 10 can be configured to correct or otherwise revise the estimated trailer brake torque determined from the lookup table. As discussed above, the LUT includes a plurality of estimated trailer brake torque τₜ₋ₑₛₜ values corresponding with preselected trailer brake signal 26 and trailer brake gain values. At each iteration of the control loop discussed above, the LUT outputs the estimated trailer brake torque τₜ₋ₑₛₜ, while also calculating the trailer brake torque τt-calc realized by the system 10. Accordingly, the output of the LUT (i.e., the trailer brake torque τt-calc) can be compared to the trailer brake torque τt-calc to determine an error therebetween. As shown in greater detail in FIG. 9, the compared error can then be fed into a separate PI controller that corrects the LUT value that was returned in that loop by adjusting the value proportionately to the error or replacing the value according to the PI output. In this respect, it is noted that the calculated trailer brake torque τ_{t-calc} is not valid for this operation during a wheel slip condition. Accordingly, the LUT correction process may be disabled while a trailer wheel slip condition is detected or by rejecting values when the wheel slip ratios are high.

In another aspect of the disclosure, the above-described process carried out by the system 10, as shown in FIG. 4, can be described as a method for mitigating wheel slip in a braked trailer wheel 36. As shown, this method includes receiving vehicle brake signal 24 (τᵥ₋ₑₛₜ) from vehicle brake system 54, vehicle acceleration signal 28 (α_{sys}) from acceleration sensor 20, and vehicle velocity signal 31 (vᵥ) from vehicle velocity sensor 30. Responsive to the vehicle brake signal 24 indicating application of the vehicle brake system 54, trailer brake signal 26 is output via trailer brake control output connection 80. The method further includes determining the effective combined brake torque (e.g., GCBT) by multiplying the combined vehicle and trailer mass (GCM) by the vehicle acceleration signal 28 and by the braked tire radius, as discussed further above. This value can be used in block 112 to determine the effective trailer brake torque by subtracting the commanded vehicle brake torque Tᵥ₋ₑₛₜ, derived from the vehicle brake signal 24, from the effective combined brake torque GCBT. This value can be used in block 114 to detect a trailer wheel 36 slip condition responsive to the effective trailer brake torque τt-calc being less than the estimated trailer brake torque τₜ₋ₑₛₜ, which is determined from the trailer brake signal 26 (such as by using the LUT in block 116). Responsive to detecting the trailer wheel 36 slip condition, the method includes adjusting the trailer brake signal 26 in block 118. As discussed above, the trailer brake signal 26 can be adjusted to reduce the trailer brake torque command using a proportional-integral control scheme (FIG. 6) that, in one example uses the difference between the effective trailer brake torque τt-calc and the estimated trailer brake torque τₜ₋ₑₛₜ as an input. Other ways of controlling the system 10 response to a trailer wheel 36 slip condition are discussed above.

During application of the vehicle brake system 54, the trailer brake signal 26 can be continuously output and the trailer wheel 36 slip condition (block 114) can be continuously detected. Using this information, the trailer brake signal 26 can be continuously adjusted (block 116), responsive to detecting the trailer wheel 36 slip condition, to converge the difference between the effective trailer brake torque τt-calc and the estimated trailer brake torque τₜ₋ₑₛₜ to below a predetermined threshold. As discussed above, the estimated trailer brake torque τₜ₋ₑₛₜ can be determined from the trailer brake signal 26 using LUT (block 116) including a set of estimated trailer brake torque values that correspond with preselected trailer brake signal 26 and trailer brake gain values. The method can include correcting (block 120) at least one of the plurality of estimated trailer brake torque values responsive to measured error between the estimated trailer brake torque τₜ₋ₑₛₜ and the calculated trailer brake torque τt-calc during a non-trailer wheel slip condition. In at least one aspect, the trailer brake signal 26 may be initially determined in block 122 based on the vehicle brake signal 24, the vehicle velocity signal 31, and at least one trailer brake system setting (which may include trailer brake gain information, as well as trailer brake system information).

It is to be understood that variations and modifications can be made on the aforementioned structure without departing from the concepts of the present disclosure, and further, it is to be understood that such concepts are intended to be covered by the following claims unless these claims by their language expressly state otherwise.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A trailer brake control system for a vehicle, comprising:
a vehicle acceleration sensor outputting a vehicle acceleration signal;
a vehicle velocity sensor outputting a vehicle velocity signal;
a vehicle brake system outputting a vehicle brake signal;
a trailer brake control output connection; and
a controller including a memory storing a combined vehicle and trailer mass, the controller:
receiving the vehicle brake signal, the vehicle acceleration signal, and the vehicle velocity signal;
responsive to the vehicle brake signal indicating application of the vehicle brake system, outputting a trailer brake signal via the trailer brake control output connection;
determining an effective combined brake torque by multiplying the combined vehicle and trailer mass by the vehicle acceleration signal and by a braked tire radius;
determining an effective trailer brake torque by subtracting a commanded vehicle brake torque, derived from the vehicle brake signal, from the effective combined brake torque;
detecting a trailer wheel slip condition responsive to the effective trailer brake torque being less than an estimated trailer brake torque, determined from the trailer brake signal; and
responsive to detecting the trailer wheel slip condition, adjusting the trailer brake signal.

2. The trailer brake control system of claim 1, wherein the controller adjusts the trailer brake signal to reduce the trailer brake torque command using a proportional-integral control scheme that uses a difference between the effective trailer brake torque and the estimated trailer brake torque as an input.

3. The trailer brake control system of claim 1, wherein the controller, during application of the vehicle brake system:
continually outputs the trailer brake signal;
detects the trailer wheel slip condition; and
responsive to detecting the trailer wheel slip condition, adjusts the trailer brake signal to converge a difference between the effective trailer brake torque and the estimated trailer brake torque to below a predetermined threshold.

4. The trailer brake control system of claim 1, wherein the estimated trailer brake torque is determined from the trailer brake signal using a lookup table including a plurality of estimated trailer brake torque values corresponding with preselected trailer brake signal and trailer brake gain values.

5. The trailer brake control system of claim 4, wherein the controller further corrects at least one of the plurality of estimated trailer brake torque values responsive to a measured error between the estimated trailer brake torque and the estimated trailer brake torque during a non-trailer wheel slip condition.

6. The trailer brake control system of claim 1, wherein the trailer brake signal is determined based on the vehicle brake signal, the vehicle velocity signal, and at least one trailer brake system setting.

7. The trailer brake control system of claim 1, wherein the braked tire radius is a single assumed value for all of a plurality of braked vehicle wheels and braked trailer wheels.

8. A trailer brake control system for a vehicle, comprising:
a vehicle acceleration sensor outputting a vehicle acceleration signal;
a vehicle velocity sensor outputting a vehicle velocity signal;
a vehicle brake system outputting a vehicle brake signal;
a trailer brake control output connection; and
a controller including a memory storing a combined vehicle and trailer mass, the controller:
receiving the vehicle brake signal, the vehicle acceleration signal, and the vehicle velocity signal;
responsive to the vehicle brake signal indicating application of the vehicle brake system, outputting a trailer brake signal via the trailer brake control output connection;
determining an effective combined brake torque by multiplying the combined vehicle and trailer mass by the vehicle acceleration signal and by a braked tire radius;
determining a commanded combined brake torque as a sum of a commanded vehicle brake torque, derived from the vehicle brake signal, and an estimated trailer brake torque, determined from the trailer brake signal;
detecting a trailer wheel slip condition responsive to the commanded combined brake torque varying from the effective combined brake torque by a predetermined amount; and
responsive to detecting the trailer wheel slip condition, adjusting the trailer brake signal to reduce a trailer brake torque command.

9. The trailer brake control system of claim 8, wherein the controller adjusts the trailer brake signal to reduce the trailer brake torque command using a proportional-integral control scheme that uses a difference between the commanded combined brake torque and the effective combined brake torque as an input.

10. The trailer brake control system of claim 8, wherein the controller, during application of the vehicle brake system:
continually outputs the trailer brake signal;
detects the trailer wheel slip condition; and
responsive to detecting the trailer wheel slip condition, adjusts the trailer brake signal to converge a difference between the commanded combined brake torque and the effective combined brake torque to below a predetermined threshold.

11. The trailer brake control system of claim 8, wherein the commanded trailer brake torque is determined from the trailer brake signal using a lookup table including a plurality of estimated trailer brake torque values corresponding with preselected trailer brake signal and trailer brake gain values.

12. The trailer brake control system of claim 11, wherein the controller further corrects at least one of the plurality of estimated trailer brake torque values responsive to a measured error between the estimated trailer brake torque and the estimated combined brake torque during a non-trailer wheel slip condition.

13. The trailer brake control system of claim 8, wherein the trailer brake signal is determined based on the vehicle brake signal, the vehicle velocity signal, and at least one trailer brake system setting.

14. The trailer brake control system of claim 8, wherein the braked tire radius is a single assumed value for all of a plurality of braked vehicle wheels and braked trailer wheels.

15. A method for mitigating wheel slip in a braked trailer wheel, comprising:
receiving vehicle brake signal from a vehicle brake system, a vehicle acceleration signal from a vehicle acceleration sensor, and a vehicle velocity signal from a vehicle velocity sensor;
responsive to the vehicle brake signal indicating application of the vehicle brake system, outputting a trailer brake signal via a trailer brake control output connection;
determining an effective combined brake torque by multiplying a combined vehicle and trailer mass by the vehicle acceleration signal and by a braked tire radius;
determining an effective trailer brake torque by subtracting a commanded vehicle brake torque, derived from the vehicle brake signal, from the effective combined brake torque;
detecting a trailer wheel slip condition responsive to the effective trailer brake torque being less than an estimated trailer brake torque, determined from the trailer brake signal; and
responsive to detecting the trailer wheel slip condition, adjusting the trailer brake signal.

16. The method of claim 15, wherein the trailer brake signal is adjusted to reduce a trailer brake torque command using a proportional-integral control scheme that uses a difference between the effective trailer brake torque and the trailer brake torque as an input.

17. The method of claim 15, wherein, during application of the vehicle brake system:
the trailer brake signal is continuously output;
the trailer wheel slip condition is continuously detected; and
the trailer brake signal is continuously adjusted, responsive to detecting the trailer wheel slip condition, to converge a difference between the effective trailer brake torque and the estimated trailer brake torque to below a predetermined threshold.

18. The method of claim 15, wherein the estimated trailer brake torque is determined from the trailer brake signal using a lookup table including a plurality of estimated trailer brake torque values corresponding with preselected trailer brake signal and trailer brake gain values.

19. The method of claim 18, further including correcting at least one of the plurality of estimated trailer brake torque values responsive to a measured error between the estimated trailer brake torque and the estimated trailer brake torque during a non-trailer wheel slip condition.

20. The method of claim 15, wherein:
the trailer brake signal is determined based on the vehicle brake signal, the vehicle velocity signal, and at least one trailer brake system setting; and
the braked tire radius is a single assumed value for all of a plurality of braked vehicle wheels and braked trailer wheels.
